(19) United States
(12) Patent Application Publication
(10) Pub. No.: US 2024/0083658 A1
(43) Pub. Date: Mar. 14, 2024

(54) BIODEGRADABLE INSULATED SHIPPING CONTAINER AND RELATED SYSTEMS AND METHODS

(71) Applicant: CFour LLC, Wilson, WY (US)

(72) Inventors: Georgios Chaliotis, Hopkinton, MA (US); Blake Reding, Des Moines, IA (US); Istiaque Ahmed, Des Moines, IA (US)

(21) Appl. No.: 18/463,621

(22) Filed: Sep. 8, 2023

Related U.S. Application Data
(60) Provisional application No. 63/404,583, filed on Sep. 8, 2022.

(51) Int. Cl. B65D 81/38; B65D 65/46

(52) U.S. Cl. CPC B65D 81/3825; B65D 65/466; B65D 81/3816; B65D 2565/382

(57) ABSTRACT

A biodegradable shipping container for providing protection to payload items being shipped against thermal effects and physical damage. An insulated panel for forming a biodegradable shipping container, the insulated panel being formed of biodegradable packing pellets placed within a cardboard box in a compressed state. A method of manufacturing insulated panels for use in forming an insulated shipping container.

### RELATED APPLICATIONS

This application claims the benefit of U.S. Provisional Patent Application No. 63/404,583, filed Sep. 8, 2022, the entire contents of which are incorporated herein by reference.

### TECHNICAL FIELD

The various embodiments herein relate to an insulated shipping container, and more particularly to a shipping container in which the insulation is biodegradable.

### BACKGROUND

When shipping items using a shipping container, it is often desirable to keep the payload items (e.g., the items being shipped) at a temperature that is relatively cool, for example, below the ambient temperature. Certain materials used to prevent damage to shipped goods and/or provide thermal protection or insulation to payload goods during shipping may be harmful to the environment through their production, use, or disposal, for example.

Accordingly, there is a need for shipping containers that can protect payload goods being shipped, maintain payload goods within a desired temperature range for certain periods of time, and that can do so using materials that reduce or minimize harm to the earth's environment.

### SUMMARY

In accordance with embodiments of the invention, a shipping container may include a plurality of insulated panels arranged to form a receptacle having an interior cavity that can receive and hold payload items. The receptacle may be sized to fit within an external box in some embodiments. The interior cavity of the receptacle may be sized to receive and hold a payload box, which can hold the payload items. In some embodiments, the interior cavity may also hold one or more coolant instruments, such as ice packs. The various components of the shipping container may be formed of recyclable materials.

In accordance with embodiments of the invention, an insulated panel for use in forming a insulated shipping container may include a panel box and a plurality of pellets or packing peanuts within the panel box. In some embodiments, a film layer is formed around the periphery or outer surface of the panel box, which may provide a seal to prevent moisture from getting inside the panel box during use. In some embodiments, the pellets or packing peanuts are placed between layers of a material to help provide a form or shape to the pellets prior to placement within the panel box. In some embodiments, the pellets are placed between layers of kraft paper and compressed to form a layer sized and shaped to fit within a panel box of the insulated panel. In various embodiments, one or more molds may be used to form the packing peanuts and/or the panel box. For example, a first mold may be used external to the panel box, and a second mold may be used to form the packing pellets or packing peanuts into a desired shape and size (with or without the use of kraft paper or laminate layers around the pellets) prior to placement into the panel box. The various components of the insulated panel may be formed of recyclable materials. In some embodiments, the pellets may be biodegradable pellets, such as pellets formed of cornstarch or other plant-based materials or plant-based starch.

In accordance with some embodiments of the invention, a process for making an insulated panel may include filling a panel box with biodegradable pellets, compressing the pellets within the box, releasing the pressure on the panel box and closing the box, and sealing the outer surface of the panel box with a biodegradable film. In some alternate embodiments, compressing the pellets may be performed separately from the box using a mold, and the compressed, formed pellet layer may be subsequently placed into the panel box. In some cases, a second mold may be used for retaining the shape of the panel box while placing the formed pellet layer within the panel box.

### BRIEF DESCRIPTION OF DRAWINGS

Those skilled in the art should more fully appreciate advantages of various embodiments of the invention from the following “Description of Illustrative Embodiments,” discussed with reference to the drawings summarized immediately below:

FIG. 1 is an exploded top perspective view of an exemplary shipping container according to some embodiments of this disclosure;

FIG. 2 is a cross-sectional view of an exemplary insulated panel of a shipping container according to some embodiments of this disclosure;

FIG. 3A is a flow chart describing steps of an exemplary method of forming the insulated panel of FIG. 2;

FIG. 3B is a flow chart describing steps of an exemplary method of forming the insulated panel of FIG. 11A;

FIG. 4 is a top view of an exemplary payload box with payload items and test apparatus used in a shipping container according to some embodiments of this disclosure;

FIG. 5 is a plot of performance test results under summer conditions for a shipping container and payload items according to some embodiments of this disclosure;

FIG. 6 is a plot of performance test results under winter conditions for a shipping container and payload items according to some embodiments of this disclosure;

FIG. 7 is a plot of performance test results under hot and humid conditions for a shipping container and payload items according to some embodiments of this disclosure;

FIGS. 8-10 are plots showing consistency of performance test results under summer conditions for successive sets of similar payload items in a shipping container according to some embodiments of this disclosure;

FIG. 11A is a cross-sectional view of an exemplary insulated panel of a shipping container according to some embodiments of this disclosure;

FIG. 11B is a top perspective view of an exemplary pellet layer of an insulated panel for use in forming an insulated shipping container according to some embodiments of this disclosure;

FIG. 11C is a top perspective view of a partially formed insulated panel including a pellet layer and a panel box according to some embodiments of this disclosure;

FIGS. 12A-12C are perspective views of exemplary molds that may be used to form an insulated panel and/or an associated pellet layer according to various embodiments of this disclosure;

FIGS. 13A-13C are perspective views of an exemplary mold being used to form an insulated panel with an associated pellet layer placed therein according to various embodiments of this disclosure; and

FIGS. 14A-14C are exploded top perspective views of exemplary arrangements of components of a shipping container according to some embodiments of this disclosure.

### DETAILED DESCRIPTION

The various embodiments herein relate to biodegradable insulated shipping containers and/or the at least one biodegradable insulated panel that makes up an insulated shipping container. In certain implementations, a biodegradable panel is provided that is made up of a panel box, a plurality of compressed pellets disposed within the panel box, and a wrap disposed around the box. Further embodiments relate to shipping containers made up of at least one insulated panel formed into an insulated receptacle, an external box that is sized to receive the insulated receptacle, and an internal payload box positionable within the insulated receptacle.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

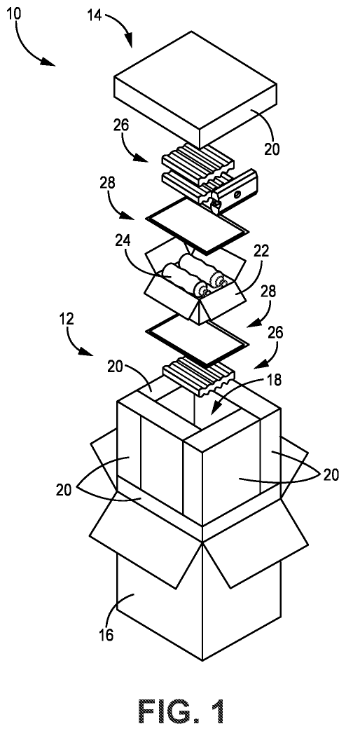

FIG. 1 is an exploded perspective view of one exemplary embodiment of an insulated shipping container 10. The shipping container 10 includes an insulated receptacle 12 with an insulated lid 14 that can be disposed within an external cardboard box 16 and further is sized and shaped to have an interior cavity 18 to receive payload items 24. In certain alternative embodiments, the container 10 can also have a payload box 22 sized to be positioned within the interior cavity 18 of the receptacle 12 and to receive the payload items 24. The insulated receptacle 12 and lid 14 are made up of insulated panels 20. Further, in some alternative implementations, the interior cavity 18 is also sized to receive—in addition to the payload items 24 (and the payload box 22 in some embodiments)—at least one coolant instrument (such as, for example, ice, dry ice, a gel pack, a hard ice pack, and/or a soft ice pack). In the specific implementation as shown, the container 10 has two hard ice packs 26 and two soft ice packs 28. The various coolant instruments (such as ice packs and/or phase change materials) can have enclosures made of recyclable materials (such as HDPE or LDPE, for example).

In various implementations, the container 10 with the two hard ice packs 26 and the two soft ice packs 28 disposed therein at a certain temperature range can protect any item contained within the container 10 from variable environmental conditions. For example, the container 10 can keep the item within a temperature range of about 2° C. to about 8° C. degrees for at least 48 hours while the ambient temperature is different. Further, the container 10 will also protect the item from any type of shipping damage (e.g. shock, vibration, compression) during that period of time.

In one embodiment, the external cardboard box 16 is made of C-flute corrugated cardboard. Alternatively, the box 16 can be made of any known biodegradable cardboard material such as paper board or the like. The box 16 can be formed into the box 16 shape via any method and/or configuration.

As noted above, the container 10 includes at least one thermally insulated panel 20. More specifically, in the exemplary container 10 embodiment as shown, the receptacle 12 is made up of six insulated panels 20. Alternatively, the receptacle 12 can have any known configuration for forming such a receptacle 12 and thus can have any number of panels 20 as needed based on the configuration.

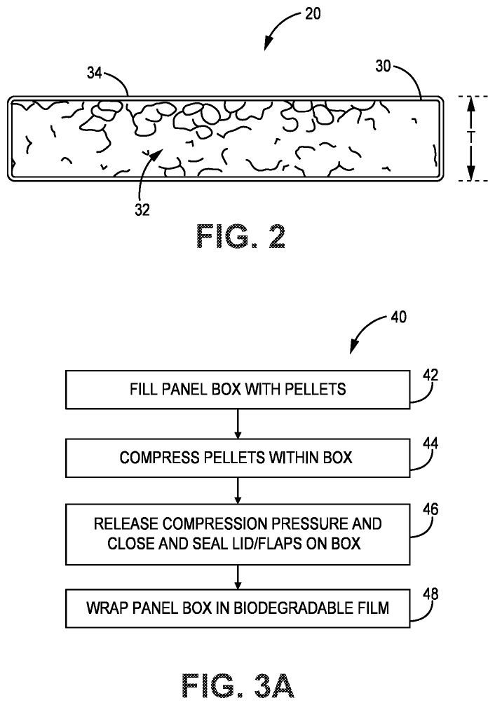

One exemplary biodegradable insulated panel 20 embodiment is depicted in further detail in FIG. 2, which shows a cross-sectional view of the components of the panel 20. The panel 20 has a panel box 30, a plurality of pellets 32 (also referred to herein as “packing peanuts” and “packing pellets”) disposed within the panel box 30, and a film 34 disposed around the box 30 as shown. In certain alternative implementations, the panel 20 can have a bio-degradable lightweight kraft paper (not shown) disposed within the box 30 such that the pellets 32 are disposed within the kraft paper. Alternatively, instead of kraft paper, the additional laminate or substrate can be any lightweight packaging laminate or substrate with properties similar to kraft paper.

In one embodiment, the panel box 30 is made of biodegradable E-flute corrugated cardboard. More specifically, the panel box 30 can be made of 32 ECT or 200 #E-flute cardboard. Alternatively, the panel box 30 can be made of any biodegradable material with the rigidity of cardboard.

According to certain implementations, the biodegradable pellets 32 are made of cornstarch. Alternatively, the pellets 32 can be made of other plant-based materials such as any other known plant-based starch. During the process of making the pellets, the ingredients (including the cornstarch or other plant-based starch as the key ingredient) are transformed into dry resins, and then the resins are extruded into the pellets 32. According to various embodiments, the process of making the pellets 32 is a known process. Alternatively, the biodegradable pellets 32 are commercially-available pellets that fall within the parameters described herein.

In certain embodiments, the pellets 32 herein have a substantially cylindrical shape. Alternatively, the pellets 32 can have any known shape for such packing peanuts 32. Each of the pellets 32 can have a diameter ranging from about 0.75 inches to about 0.9 inches and a height ranging from about 0.5 inches to about 1.5 inches. Alternatively, each of the pellets 32 have a diameter of about 0.75 inches and a height of about 1.25 inches. Each of the pellets 32 can have a density ranging from about 0.4 lb/ft³ to about 0.5 lb/ft³. Each of the pellets 32 can have a weight ranging from about 0.12 grams to about 0.19 grams. Alternatively, each of the pellets 32 can have a weight of about 0.15 grams.

In some iterations, the panel box 30 can contain about 300 to about 500 grams of pellets 32. In certain embodiments, the box 30 can contain about 353 grams of pellets 32. In certain other embodiments, the box 30 can contain about 486 grams of pellets 32. Alternatively, panel box 30 can contain about 300 to about 400 grams of pellets 32. In a further alternative, the amount of pellets 32 depends on the size of the box 30. In certain embodiments, the box 30 can contain pellets 32 in a ratio of about 1.5 to about 4.0 lbs. of pellets per 1 cubic foot of volume. In other embodiments, the box 30 can contain pellets 32 in a ratio of about 2.5 lbs. to about 3.7 lbs. of pellets per 1 cubic foot of volume. In a further alternative, the ratio can be about 0.4 to 1.0 grams of pellets 32 per 1 cubic inch, and in certain embodiments, the ratio can be about 0.66 to 0.97 grams of pellets 32 per 1 cubic inch.

The film 34 can be a commercially-available biodegradable shrink wrap 34 such as Biolefin 2.0 or Oxo-Biodegradable Shrink Film 60 gauge. Alternatively, the shrink wrap 34 can be any known biodegradable shrink wrap for use in packaging. The shrink wrap 34 can provide a fluidic seal such that contents of the panel 20 (including the pellets 32 and panel box 30) are fluidically sealed from the external or ambient air and moisture. Thus, the shrink wrap 34 and the resulting fluidic seal can prevent any moisture produced by the contents of the container 10 (such as any ice packs, phase change materials, and/or payload items) from reaching the pellets 32. Alternatively, the film 34 can be made of any known material with similar characteristics.

The resulting insulation panel 20 can have a thickness T (as identified by the letter “T” in FIG. 2) ranging from about 1 inch to about 4 inches. Alternatively, the panel 20 can have a thickness T ranging from about 2.75 to about 3.5 inches. The thickness T of the panel 20 is considered to be along its narrowest dimension, whereas the length and width of the panel 20 are considered to be along the two directions along the primary face, perpendicular to the thickness T. The length and width of the various panel 20 embodiments herein can be any dimensions as needed for the size of the resulting shipping container. In the exemplary embodiment as shown, the panel 20 has a length of about 16 inches and a width of about 14 inches. In some embodiments, the panel 20 may have a length of about 14.5 inches and a width of about 12.5 inches.

The resulting panel 20, in accordance with certain implementations, has a thermal conductivity coefficient ranging from a value of about 0.03 watts per meter-Kelvin (“W/mK”) to about 0.09 W/mK, and in some specific embodiments, may have a thermal conductivity coefficient ranging from a value of about 0.036 W/mK to about 0.042 W/mK.

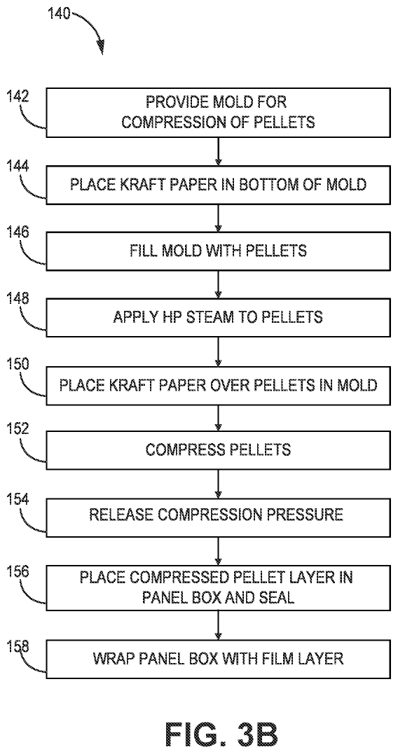

In one embodiment, the various panel 20 embodiments herein can be made using the following process or method 40, as depicted in FIG. 3A. As an initial step of method 40, the pellets 32 are added to the interior of the panel box 30 (Step 42). In certain implementations, the panel box 30 may be placed within a first mold (not shown in FIG. 3A), a second mold (also not shown in FIG. 3A) may be placed inside the panel box 30, and then the second mold is filled with pellets 32 in an amount as set forth above. Once the pellets 32 are disposed within the panel box 30, the pellets 32 are compressed (Step 44). More specifically, the pellets 32 are compressed with a compression of more than about 3.5 pounds per square inch (“psi”) applied to the pellets 32 to compact the pellets 32 into a pellet layer having a thickness of about half the total intended thickness T of the panel 20. The compressed pellets 32 may expand over time to fill a volume inside the panel box 30. Thus, if the target thickness of the panel 20 is about 3.5 inches, then the pellets 32 are, in some embodiments, compressed to a thickness of about 1.75 inches. Alternatively, the pellets 32 can be compressed to any known thickness to achieve desired thermal insulation properties, or to achieve certain impact protection qualities, or both.

Once the desired thickness is achieved, the compression pressure is released and the cavity of the panel box 30 is closed by closing the lid or flaps of the box 30 (Step 46). Once the box 30 is closed, a film layer 34 (e.g., a shrink wrap 34) is placed around the panel box 30 to enclose the box 30 in the wrap 34 (Step 48). In certain embodiments, heat may then be applied to the panel box 30 and/or to the film layer (wrap 34) to shrink the wrap 34 and thereby fluidically seal the box 30 within the wrap 34.

Alternatively, any known process can be used for adding the pellets 32 to the panel box 30, compressing the pellets 32, and enclosing the panel box 30 in the wrap 34.

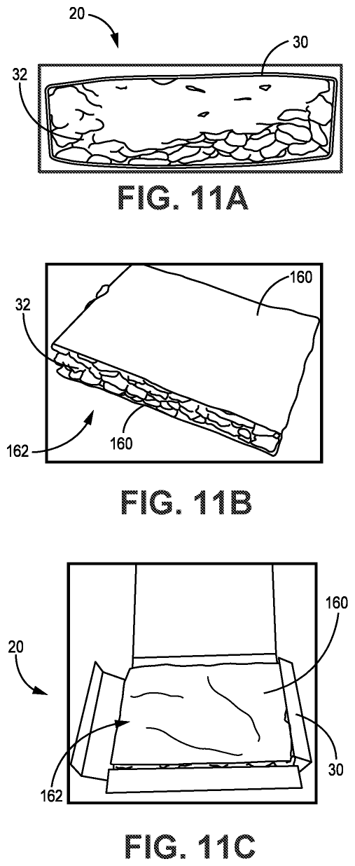

An exemplary alternative process for forming or producing the insulated panels 20 of this disclosure may include one or more of the following steps described and illustrated as process or method 140 with respect to the flowchart shown in FIG. 3B and with reference to FIGS. 11A-11C and FIGS. 13A-13C.

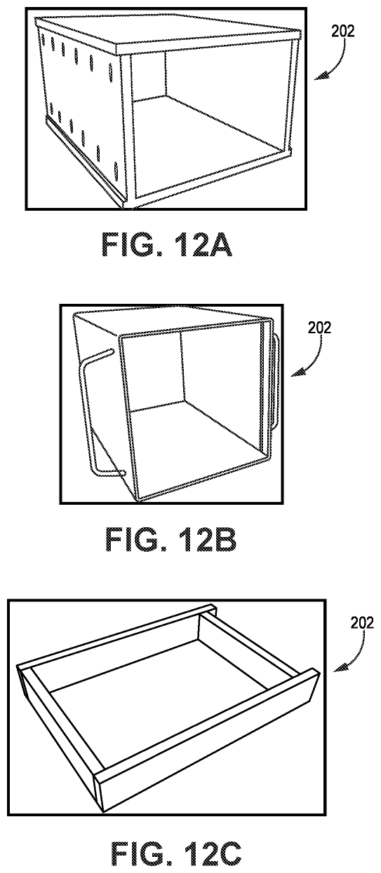

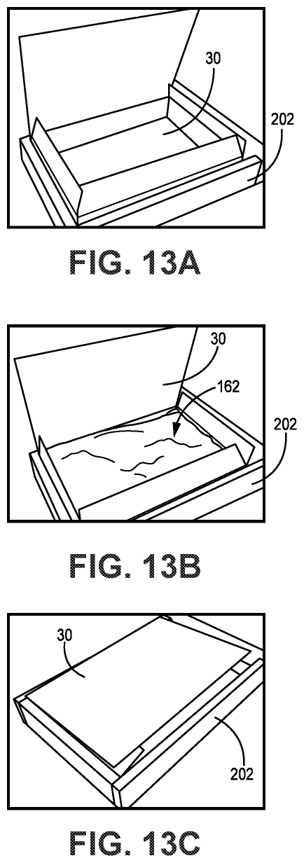

Step 142 may include providing a first mold for use in compressing the pellets 32. In some embodiments, a hollow rectangular mold 202 (see exemplary molds 202 in FIGS. 12A-12C and FIGS. 13A-13C, for example) may be used as a compression chamber for compressing the pellets 32. The size of the mold 202 will vary depending on the desired size and thickness of the insulated panel 20 to be formed. For example, in some implementations, mold 202 may have inner dimensions of 11.5″×11.5″×1.7″ (inner dimensions) for making insulated panels 20 having dimensions of 11.75″×11.75″×2.0″

Step 144 may include placing kraft paper 160 in a bottom portion of mold 202. As noted previously, other materials may be used having similar properties as kraft paper, such as certain laminates, etc. Preferably, the layer 160 is formed of biodegradable and/or recyclable materials.

Step 146 may include placing pellets 32 onto kraft paper 160 inside mold 202 to fill the mold 202. Pellets 32 may be cornstarch pellets or other plant-based or biodegradable materials.

Step 148 may include applying a steam or mist inside the mold 202 while filling with pellets 32 to achieve some level of bonding between the pellets 32. In some implementations, the steam/mist may be applied at a high pressure while filling the mold with cornstarch pellets to achieve the desired level of bonding between pellets 32. In some implementations, the steam pressure and temperature should be at least 50 psi and 212° F. The application of steam (in particular, steam under pressure or high pressure steam) during the pellet filling step (Step 146) may facilitate having the pellets 32 stick together in a formed pellet layer 162 (see FIGS. 11B and 11C) following a subsequent step of compression (to be described below).

Step 150 may include placing a second layer of kraft paper 160 over the pellets 32 after filling the mold with pellets 32, for example. The use of sheets of kraft paper 160 above and below (e.g., on both major sides) the layer of pellets 32 may help avoid sticking of the compressed pellet layer 162 (to be formed in Step 152) with a press plate or the base of a press machine when they are being compressed.

Step 152 may include compressing the pellets 32 in the mold to form a pellet layer 162 (see FIGS. 11B and 11C). The amount of compression of pellets 32 may be determined based on the desired thickness of insulated panels 20 (e.g., a typical amount of compression ranges from about 0.5× thickness of the panel 20 to 0.75× thickness of the panel 20 due to allowing for the insulating panels 20 to expand back to the size of the desired resulting panels (e.g., after releasing the compression pressure). The pellet layer 162 will resemble a “sandwich” of compressed pellets 32 between a top layer and bottom layer of kraft paper 160 following the compression step (Step 152).

Step 154 may include releasing the compression pressure applied to the pellets 32 and kraft paper 160. This may involve reducing or removing the amount of compression pressure applied between press plates of a press machine, for example.

Step 156 may include placing the compressed pellet layer 162 inside a panel box 30 (e.g., inside the cardboard enclosure of the panel box 30), and sealing the enclosure (e.g., sealing the lids or flaps of panel box 30 with an adhesive such as glue, etc.). FIGS. 13A-13C show the use of an outer mold 202 to retain the shape of panel box 30 while placing pellet layer 162 inside panel box 30 according to some embodiments.

Step 158 may include wrapping the panel box 30 with a film 34 (e.g., a biodegradable shrink wrap or a fluid-resistant material) or leaving it as is depending on the application or intended use of the particular shipping container 10 being formed (e.g., if humidity is a concerning factor, then the panel box 30 may be wrapped using biodegradable shrink wrap 34 or waxed paper 34. If duration of the shipment in the shipping container 10 is less than 48 hours, it may be acceptable to use insulated panels 20 that are unwrapped, in some cases).

The term “about” indicates a variation of as much as about 10% in the dimensions as set forth herein. Further, it should be understood that although various terms such as “top,” “bottom,” “vertical,” and “lateral” may be used herein, these terms indicate relative positioning of components under the assumption that an opening to any of the containers/boxes herein is at the top, and don't necessarily indicate an orientation relative to gravity; in use, or even during assembly, any container embodiment herein could be on its side or upside down relative to gravity.

The various biodegradable shipping container embodiments disclosed or contemplated herein can be used for transporting cold-chain products using eco-friendly materials that help to reduce environmental pollution and/or the environmental footprint. Further, the various implementations herein can maintain a safe temperature zone for any payload items while also providing structural support to prevent damage from any external impacts.

In certain specific embodiments, the various container iterations disclosed or contemplated herein are designed to maintain payload items at a temperature ranging from about 2° to about 8° C. for at least 48 hours.

### Example

One embodiment of an insulated shipping container having the dimensions described above with respect to FIG. 1 was tested in various external conditions to determine whether the container could maintain the payload items at the target temperature for the desired period of time.

To achieve the overall performance of the shipping container, the test methods were divided into four different testing parameters/environments: (1) hot and humid conditions, (2) summer conditions, (3) winter conditions, and (4) consistency in summer conditions. For the hot and humid weather conditions, a consistent temperature (+26 to +27° C.) was applied throughout the duration at a relative humidity of greater than 92%. The summer environment utilized the parameters of the ISTA 7D summer environment, while the winter environment utilized the parameters of the ISTA 7D winter environment. In the consistency test, three identical insulated containers were compared using the parameters of the ISTA 7D summer environment.

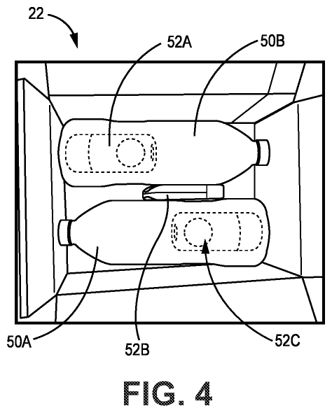

As shown in FIG. 4, two 500 ml standard water bottles 50A, 50B were used as the payload items 24 in each container 10 for the tests. More specifically, the two bottles 50A, 50B were placed in the payload box 22, along with three temperature sensors and dataloggers 52A, 52B, 52C positioned as shown that were used to measure the temperature throughout the payload box 22. More specifically, one datalogger 52A was positioned on top of bottle 50B, another datalogger 52B was positioned between the two bottles 50A, 50B, and another datalogger 52C was disposed under bottle 50A.

All the tests were performed in a standard environmental chamber. Prior to each test, the water bottles 50A, 50B, the dataloggers 52A-C, and the soft packs 28 were preconditioned in the refrigerator at +2 to +8° C. for at least 48 hours prior to start the test. For the summer weather tests, all the hard packs 26 were pre-conditioned at −21 to −27° C. for at least 96 hours prior to start the test, while all soft packs 28 were pre-conditioned at +2 to +8° C. for at least 48 hours prior to start the test. And for the winter weather tests, all the soft 28 and hard 26 packs were pre-conditioned at +2 to +8° C. for at least 48 hours prior to start the test. Further, prior to testing, the container to be tested was stored in a controlled room temperature and humidity environment.

### Results

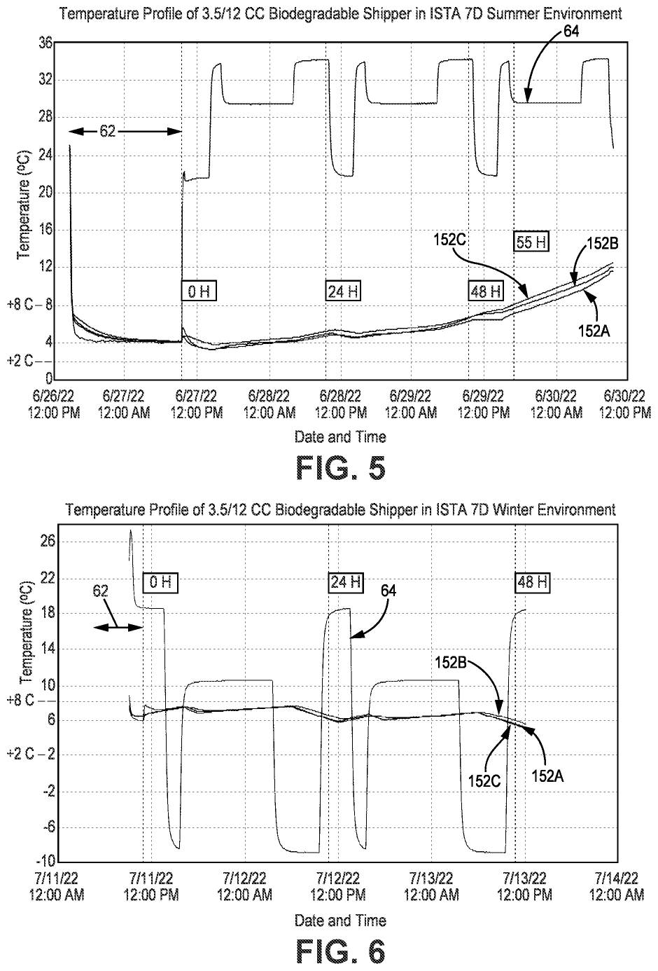

The summer performance test results are provided in the graph depicted in FIG. 5. From the graph, it is clear that all the temperature readings from the dataloggers 52A-C within the payload box 22 are in between +2 to +8° C. for a duration of at least 55 hours. In the graph, the black curve 64 represents the ambient temperature, the red line 152A represents the temperature around the top side of the payload products 24 (e.g., data collected from the top datalogger 52A, appearing on top of bottle 50B in FIG. 4), the yellow line 152B is the temperature in the middle of the payload items 24 (e.g., data collected from the middle datalogger 52B, appearing between bottles 50A and 50B in FIG. 4), and the green line 152C represents the temperature around the bottom side of the payload products 24 (e.g., data collected from the bottom datalogger 52C, indicated as being beneath bottle 50A in FIG. 4). The durations are marked by time periods 0 hour (starting the test), 24 hours, 48 hours and 55 hours. The data before 0 hour represents the pre-testing storage period 62 of the payload products or items 24.

The winter performance test results are provided in the graph shown in FIG. 6. As shown in the graph, all of the dataloggers' readings within the payload box 22 are between +2 to +8° C. for a time duration of at least 48 hours. As above, the black curve 64 represents the ambient temperature, the red line 152A represents the temperature around the top side of the payload products 24 (e.g., data collected from the top datalogger 52A), the yellow line 152B is the temperature in the middle of the payload items 24 (e.g., data collected from the middle datalogger 52B), and the green line 152C is the temperature around the bottom side of the payload products 24 (e.g., data collected from the bottom datalogger 52C). The data before 0 hour represents the pre-testing storage period 62 of the payload products 24.

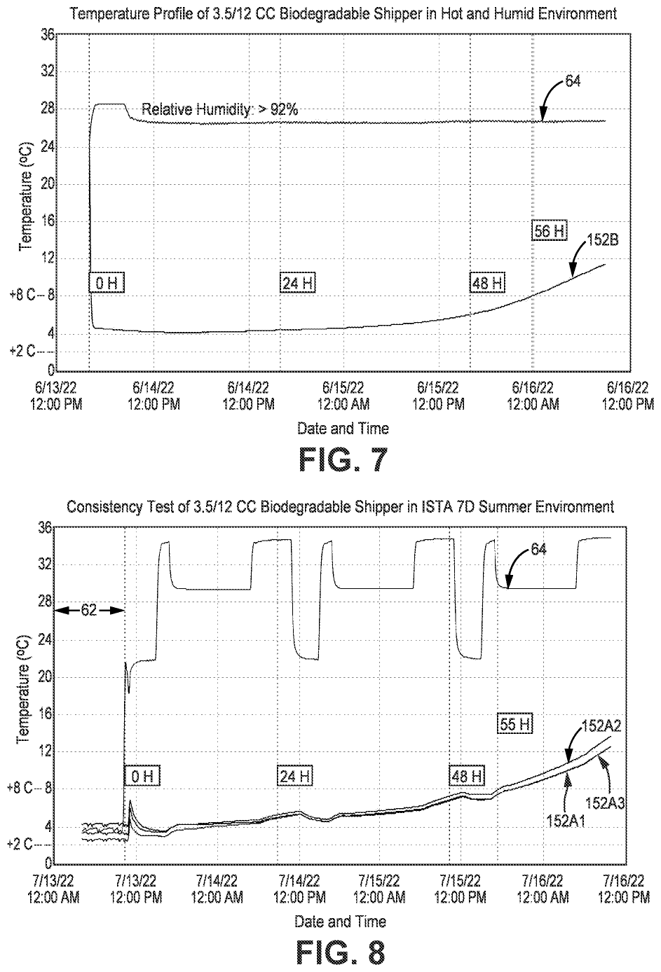

The hot and humid weather test results are provided in FIG. 7. In this test, only the middle datalogger 52B was used. As shown, the datalogger's readings within the payload box 22 are between +2 to +8° C. for a duration of at least 56 hours. In this graph, the black line 64 represents the ambient temperature, while the red line 152B represents the temperature in the middle (e.g., data collected from the middle datalogger 52B).

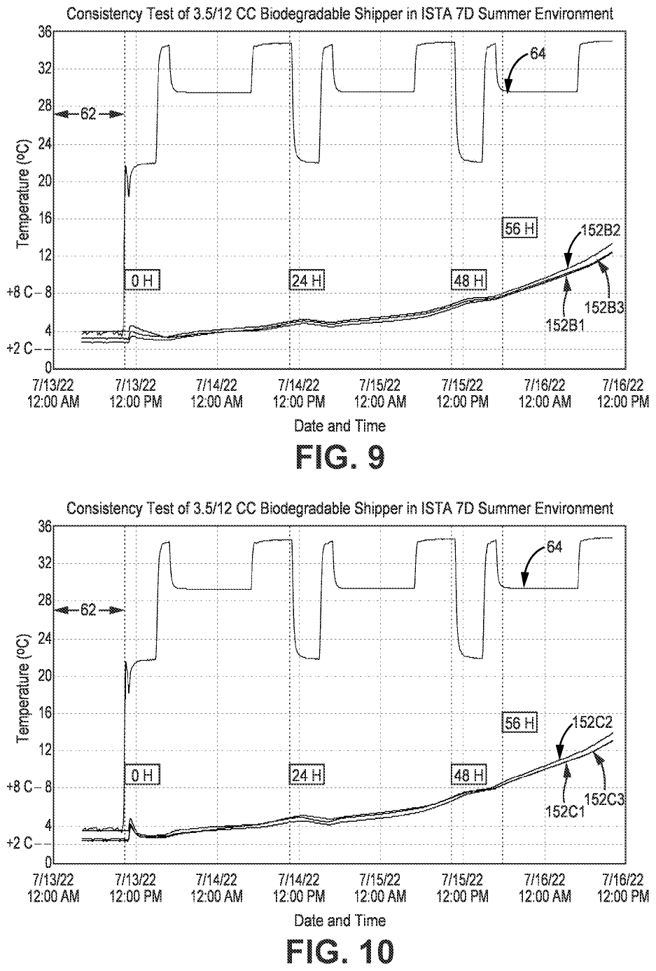

After performing the above tests relating to various simulated weather conditions, a consistency test was performed to verify the overall performance of the insulated container 10. For this test, three identical containers were prepared and packed with the same ice packs, phase change materials, and payload products. The chosen ambient weather conditions for this test was the ISTA 7D summer profile. Each of FIGS. 8, 9, and 10 depict the temperature readings from the top, middle, and the bottom dataloggers 52A-C, respectively, of a different one of the three separate boxes. In other words, FIG. 8 is a plot of the top dataloggers 52A for each of the three different containers, FIG. 9 is a plot of the middle dataloggers 52B for each of the three different containers, and FIG. 10 is a plot of the bottom dataloggers 52C for each of the three different containers. It is noted that the readings in each of the three graphs are very similar, which means that the three separate insulated containers performed consistently. In each of the containers, the top dataloggers 52A recorded temperatures within the desired temperature range for at least 55 hours, the middle dataloggers 52B recorded temperatures within the desired range for at least 56 hours, and the bottom dataloggers 52C recorded temperatures within the desired range for at least 53 hours. As a result, it can be concluded that the insulated container's performance can be verified for the minimum accepted duration (48 hours).

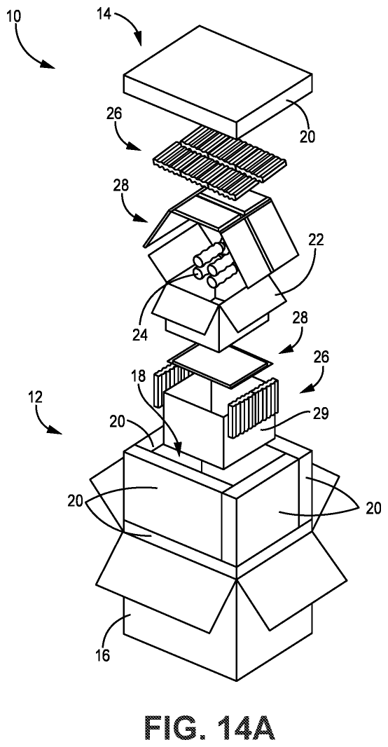

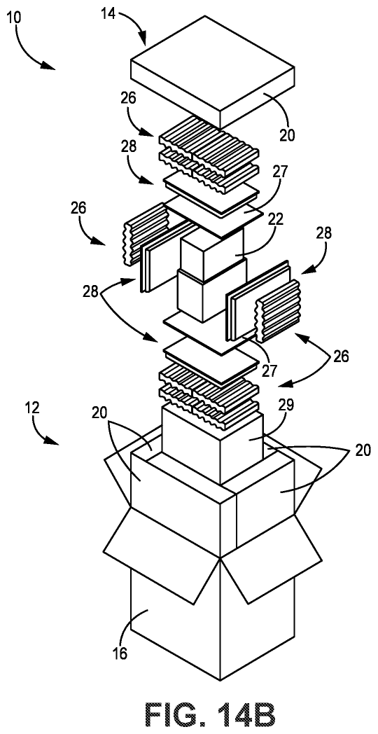

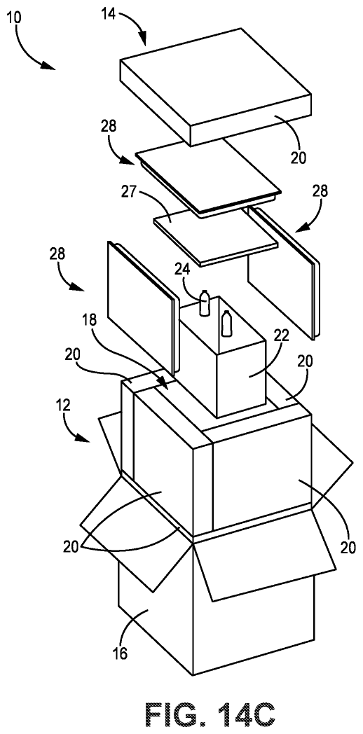

FIGS. 14A-14C depict a series of alternative arrangements of components forming shipping container 10 according to embodiments of this disclosure. For example, FIGS. 14A and 14B depict the use of different numbers of hard ice packs 26 and soft ice packs 28, as well as differing positions of said ice packs 26, 28. In the embodiments depicted in FIGS. 14B and 14C, for example, the additional use of a cardboard separator 27 is shown positioned relative to a payload box or payload sleeve 22 according to some embodiments. In FIG. 14C, there are no hard ice packs 26 used; in such an embodiment, the use of a cardboard separator 27 may provide additional structural support and/or insulation in combination with the use of soft ice packs 28. The shipping containers 10 of FIGS. 14A and 14B also depict the use of an inner box 29 that may be useful to provide additional structural support and/or thermal insulation between the receptacle 12 and the payload box 22 according to some embodiments. Other possible arrangements of the aforementioned components of shipping container 10 will become apparent to those skilled in the art and are contemplated by this disclosure.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

The embodiments of the invention described above are intended to be merely exemplary; numerous variations and modifications will be apparent to those skilled in the art. Such variations and modifications are intended to be within the scope of various embodiments.

What is claimed is:

1. An insulated panel for a shipping container, the insulated panel comprising:
(a) a panel box comprising cardboard;
(b) a plurality of biodegradable pellets disposed within the panel box; and
(c) a film disposed around the panel box,
wherein the plurality of biodegradable pellets disposed within the panel box are compressed at a pressure ranging from about 3 pounds per square inch to about 4 pounds per square inch.

2. The insulated panel of claim 1, wherein the plurality of biodegradable pellets disposed within the panel box are compressed at a pressure of about 3.5 pounds per square inch.

3. The insulated panel of claim 1, further comprising a lining disposed within the panel box, wherein the plurality of biodegradable pellets are disposed within the lining.

4. The insulated panel of claim 3, wherein the lining comprises an upper layer of kraft paper and a lower layer of kraft paper, and wherein the plurality of biodegradable pellets is disposed between the upper layer of kraft paper and the lower layer of kraft paper.

5. The insulated panel of claim 1 wherein the plurality of biodegradable pellets are formed of plant-based materials.

6. The insulated panel of claim 5 wherein the plurality of biodegradable pellets are generally cylindrical, the biodegradable pellets each having a diameter ranging from about 0.5 inches to about 1.0 inches, and having a height ranging from about 1.0 inches to about 2.0 inches period.

7. The insulated panel of claim 5 wherein the plurality of biodegradable pellets compressed in the panel box has a density ranging from about 1.5 pounds per cubic foot to about 4.0 pounds per cubic foot.

8. The insulated panel of claim 1 wherein the film comprises a biodegradable shrink wrap.

9. The insulated panel of claim 8 wherein the biodegradable shrink wrap is heated to form a fluidic seal around an outer periphery of the insulated panel.

10. A method of making an insulated panel for a shipping container, the method comprising:
placing a plurality of biodegradable pellets within a panel box;
compressing the plurality of biodegradable pellets with a pressure ranging from about 3 pounds per square inch to about 4 pounds per square inch such that the panel box and the plurality of biodegradable pellets are compressed to an initial thickness that is less than a desired final thickness of the insulated panel;
releasing the pressure from compressing the plurality of biodegradable pellets; and
placing a film around the panel box.

11. The method of claim 10, wherein the pressure is about 3.5 pounds per square inch.

12. The method of claim 10, wherein the panel box and the plurality of biodegradable pellets are compressed to the initial thickness, wherein the initial thickness is about half of the desired final thickness.

13. The method of claim 10 further comprising using at least one mold while compressing the plurality of biodegradable pellets.

14. The method of claim 10 further comprising placing at least one sheet of kraft paper within the panel box prior to compressing the plurality of biodegradable pellets.

15. A method of making an insulated panel for a shipping container, the method comprising:
providing a first mold, the first mold being generally rectangular;
placing a first layer of kraft paper in a bottom portion of the first mold;
placing a plurality of biodegradable pellets over the first layer of kraft paper in the first mold;
applying steam to the plurality of biodegradable pellets in the first mold;
placing a second layer of kraft paper over the plurality of biodegradable pellets in the first mold;
applying a compression pressure to the first mold to compress the plurality of biodegradable pellets between the first layer of kraft paper and the second layer of kraft paper to thereby form a compressed pellet layer comprising the plurality of biodegradable pellets and the first and second layers of kraft paper; and
placing the compressed pellet layer within a panel box.

16. The method of claim 15, further comprising:
placing a film layer around an outer periphery of the panel box.

17. The method of claim 16, wherein the film layer comprises a shrink wrap layer to create a fluidic seal around the panel box.

18. The method of claim 16, further comprising:
sealing the panel box prior to placing the film layer.

19. An insulated shipping container comprising:
a receptacle comprising at least four insulated panels arranged to form an interior cavity for holding one or more payload items to be shipped, each of the at least four insulated panels comprising:
a panel box; and
a plurality of packing pellets compressed within the panel box, the plurality of packing pellets being formed of biodegradable materials;
one or more ice packs;
a payload box for holding the one or more payload items to be shipped; and
an external cardboard box,
wherein the interior cavity of the receptacle is sized and configured to house the payload box and the one or more ice packs;
wherein the external cardboard box is sized and configured to house the receptacle positioned therewithin; and
wherein at least the receptacle, the payload box, and the external cardboard box of the shipping container are made of biodegradable or recyclable materials.

20. The insulated shipping container of claim 19 wherein the at least four insulated panels further comprise a shrink wrap layer disposed around an outer surface of the panel box, and wherein the plurality of packing pellets are compressed between a first layer of kraft paper and a second layer of kraft paper to form a pellet layer prior to the pellet layer being placed within the panel box.
